(19) United States
(12) Patent Application Publication
(10) Pub. No.: US 2013/0250203 A1
(43) Pub. Date: Sep. 26, 2013

(54) BACKLIGHT MODULE STRUCTURE AND LIQUID CRYSTAL DISPLAY DEVICE USING THE SAME

(71) Applicant: Gege Zhou, Shenzhen (CN)

(72) Inventor: Gege Zhou, Shenzhen (CN)

(21) Appl. No.: 13/517,484

(22) PCT Filed: May 3, 2012
(86) PCT No.: PCT/CN12/75016

§ 371 Date: Jun. 20, 2012

(30) Foreign Application Priority Data
Mar. 23, 2012 (CN) 201210080658.9

(51) Int. Cl. F21V 13/02; G02F 1/13357; G02F 1/1333; F21V 8/00; F21V 29/00

(52) U.S. Cl. 349/58; 362/615; 362/624; 362/627; 362/611

(57) ABSTRACT

The backlight module structure includes a front frame and a back cover cooperating with each other, and a middle frame and a light guide plate being disposed between the front frame and the back cover. The middle frame is made of an elastic material and the light guide plate is engaged with the middle frame. The liquid crystal display device includes the backlight module structure. The backlight module structure and the liquid crystal display device can reduce manufacturing costs and enhance dependability.

### FIELD OF THE INVENTION

The present invention relates to a liquid crystal display device and more particularly to a backlight module structure of the liquid crystal display device using the same.

### BACKGROUND

Please refer to FIGS. 1 and 2; a conventional backlight module comprises a front frame 1, a middle frame 3, an optical film 4, a light guide plate 5, a light bar 6 and a back cover 7. The front frame 1, the middle frame 3 and the back cover 7 have different functions: the front frame 1 being used for securing a panel 2 and preventing it from tripping off; the middle frame 3 being used for supporting the panel 2 and for preventing light from leaking out partially; the back cover 7 being used for supporting all the parts and ensuring the flatness of the backlight module. The light guide plate 5 is secured by a rivet 9 riveted on the back cover 4. An installation gap d is disposed between the light guide plate 5 and the middle frame 3. The light bar 6 is installed by a lateral side of the light guide plate 5 and the heat generated is dissipated via the connection of a heat conduction glue strip 8 and the back cover 7. The conventional middle frame 3 is usually made by plastic injection molding and the manufacturing period of the mould used for injection molding is long and the cost is high. Furthermore, the light guide plate 5 needs to be cut to form a securing groove for accommodating the rivet 9 and the cost is increased because of the processing. Hotspot is easily generated on corresponding part of the picture by the rivet 9 which will affect the optical quality. This problem especially occurs in liquid crystal displays with a slim bezel and is difficult to solve. When an impact occurs, the part of the light guide plate 5 for accommodating the rivet 9 can be easily fractured because of the acting force between the part and the rivet 9, and the dependability of the backlight module is affected seriously. Therefore, the structure of the conventional backlight module needs to be improved.

### SUMMARY

One objective of the present invention provides a backlight module structure which uses a middle frame for elastically fixing and engaging with a lateral side of light guide plate, the cost can be reduced and the dependability can be enhanced.

In order to achieve the abovementioned objective, the present invention provides a backlight module structure which comprises a front frame and a back cover coordinating with each other, and a middle frame and a light guide plate disposing between the front frame and the back cover. The middle frame is made of a rubber material. The lateral side of the light guide plate is engaged with an inner side of the middle frame. When the light guide plate absorbs thermal energy and moisture, it produces expansion which can be absorbed by the middle frame. The light guide plate is recovered from being expanded by elasticity when the external environment is restored to normal.

In one embodiment, it further comprises a reflective film which is disposed under a bottom of the light guide plate.

In one embodiment, a bottom of the reflective film which is disposed on the back cover.

In one embodiment, the backlight module structure further comprises an optical film being disposed on a light emitting surface of the light guide plate.

In one embodiment, the backlight module structure further comprises light-bar, wherein the light-bar is installed at a light entrance surface of the light guide plate.

In one embodiment, the backlight module structure further comprises a heat conduction glue strip which is adhered between the light-bar and an inner of the back cover.

In order to achieve the abovementioned objective, the present invention further provides a backlight module structure which comprises a front frame and a back cover cooperating with each other, and a middle frame and a light guide plate being disposed between the front frame and the back cover, wherein the middle frame is made of an elastic material, and the lateral side of the light guide plate is engaged with an inner side of the middle frame.

In one embodiment, when the light guide plate produces expansion due to absorbing thermal energy and moisture, the light guide plate produces expansion which is absorbed by middle frame, and the light guide plate is recovered from being expanded by elasticity when the external environment is restored to normal.

Preferably, the middle frame is made of a rubber material.

In order to achieve the abovementioned objective, the present invention further provides a liquid crystal display device which comprises a front frame and a back cover cooperating with each other, and a middle frame and a light guide plate being disposed between the front frame and the back cover, wherein the middle frame is made of a rubber material, and the lateral side of the light guide plate is engaged with an inner side of the middle frame.

In one embodiment, when the light guide plate produces expansion due to absorbing thermal energy and moisture, the expansion is absorbed by the middle frame, and the light guide plate is recovered from being expanded by elasticity when the external environment is restored to normal.

Preferably, the middle frame is made of a rubber material.

In one embodiment, it further comprises a reflective film which is disposed under a bottom of the light guide plate.

In one embodiment, a bottom of the reflective film is disposed on the back cover.

In one embodiment, the backlight module structure further comprises an optical film being disposed on a light emitting surface of the light guide plate.

Comparing with the conventional technique, the backlight module structure and the liquid crystal display device having the same of the present invention employ an elastic material to make the middle frame, and the middle frame is used for elastically fixing and engaging with a lateral side of light guide plate, such that the cost can be reduced and the dependability can be enhanced.

### BRIEF DESCRIPTION OF THE DRAWINGS

FIG. 1 is an exploded perspective view of a conventional backlight module structure;

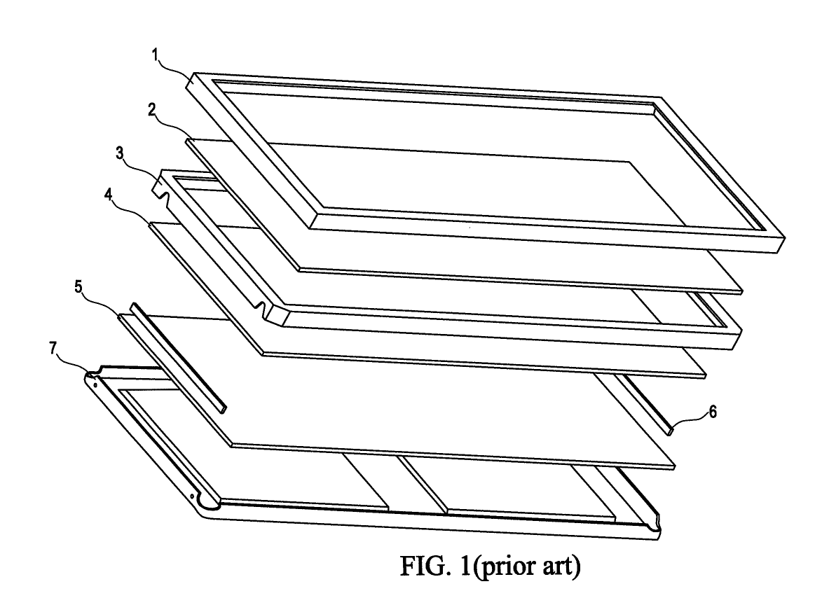

FIG. 2 is a sectional view of the convention backlight module structure; and

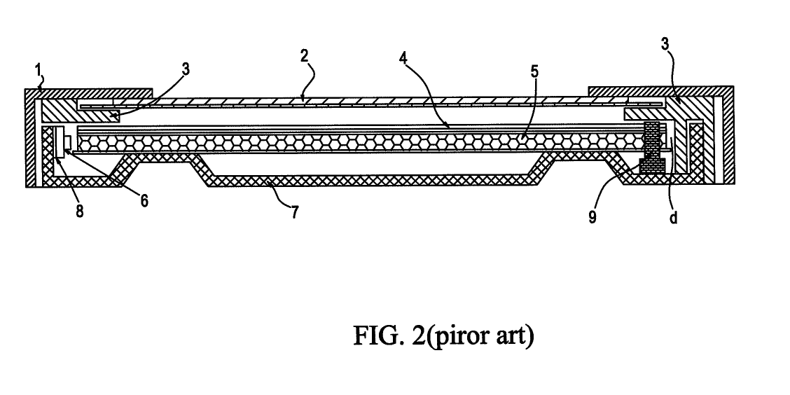

FIG. 3 is a sectional view of a backlight module structure according to an embodiment of the present invention.

### DETAILED DESCRIPTION OF THE INVENTION

The present invention will become more fully understood by reference to the following detailed description thereof when read in conjunction with the accompanying drawings.

The present invention provides a backlight module structure which comprises a front frame and a back cover cooperating with each other, and a middle frame and a light guide plate being disposed between the front frame and the back cover. The middle frame is made of an elastic material. The lateral side of the light guide plate is engaged with an inner side of the middle frame. In addition, when the light guide plate produces expansion due to absorbing thermal energy and moisture, the expansion is absorbed by middle frame, and the light guide plate is recovered from being expanded by elasticity when the external environment is restored to normal.

The present invention further provides a liquid crystal display device which comprises the above-mentioned backlight module structure.

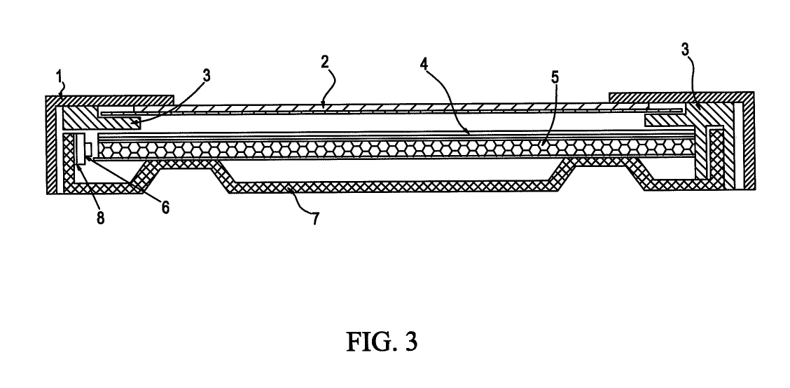

Please refer to FIG. 3, an embodiment of the backlight module structure of the present invention comprises a front frame 1, a middle frame 3, an optical film 4, a light guide plate 5, a light bar 6, a back cover 7 and a heat conduction glue strip 8. A panel 2 can be disposed by the coordination of the front frame 1 and the middle frame 3. A reflective film can be disposed under a bottom surface of the light guide plate 5 and the reflective film is disposed on the back cover 7. The optical film 4 is disposed on a light emitting surface of the light guide plate 5. The heat conduction glue strip 8 is adhered between the light bar 6 and an inner side of the back cover 7. The heat dissipation of the light bar 6 can be enhanced via the connection of the heat conduction glue strip 8 and the back cover 7.

The middle frame 3 is made of rubber which has excellent elasticity and buffering effect. The middle frame 3 is disposed between the light guide plate 5 and the back cover 7. The lateral side of the light guide plate 5 is engaged with the inner side of the middle frame 3. Thereby, when the light guide plate 5 produces expansion due to absorbing thermal energy and moisture, the expansion is absorbed by the middle frame 3, and the light guide plate 5 is recovered from being expanded by elasticity when the external environment is restored to normal. Because the middle frame 3 is made of a rubber material, both the forming period and the cost can be reduced. Furthermore, because the middle frame 3 is made of a rubber material, the rivet employed in the conventional backlight module structure can be omitted. Cutting is not required for the light guide plate 5 for connecting with the rivet, thereby the picture quality problem caused by the disposing of the rivet can be avoided. Therefore, the liquid crystal display device with a slim bezel can be achieved and the fracturing of the light guide plate 5 caused by impact can be avoided. As a result, the dependability of the backlight module structure and the liquid crystal display device can be enhanced.

It should be noted that, an avoiding structure is disposed on a lateral side of the middle frame 3 where the light bar 6 is installed. The light guide plate 5 and the middle frame 3 are not closely engaged with each other at this position.

Even though the middle frame 3 is made of a rubber material in the above embodiment; in other embodiments, the middle frame 3 can also be made of any other materials with elasticity such as polymeric materials which have similar performances of rubber as long as the expansion of the light guide plate 5 caused by heat and damp can be taken up by the middle frame 3, and the light guide plate 5 can be recovered from being expanded by the elasticity of the middle frame 3 when the external environment is restored to normal. Preferably, the materials employed for replacing rubber have lower costs than rubber and are easier to be processed and formed.

Even though the lateral side of the light guide plate 5 is engaged with the middle frame 3; in other embodiments, both the lateral side and a top side of the light guide plate 5 can be engaged with the middle frame 3; or both the lateral side and a bottom side of the light guide plate 5 can be closely fitting with the middle frame 3; or the lateral side, the top side and the bottom side of the light guide plate 5 can be engaged with the middle frame 3. Furthermore, the middle frame 3 can engaged with the light guide plate 5 along the entire lateral side of the light guide plate 5 continuously or along at least one section of the lateral side of the light guide plate 5 discontinuously.

For the engagement of the middle frame 3 with the top side of the light guide plate 5, because the optical film 4 can be disposed on the top side of the light guide plate 5, the optical film 4 can be extended to the edge of the light guide plate 5. Therefore, the middle frame 3 can be engaged with the top side of the light guide plate 5 via the optical film 4. Furthermore, the optical film 4 is not extended to the edge of the light guide plate 5 and the middle frame 3 can be engaged with the top side of the light guide plate 5 directly.

Note that the specifications relating to the above embodiments should be construed as exemplary rather than as limitative of the present invention, with many variations and modifications being readily attainable by a person of average skill in the art without departing from the spirit or scope thereof as defined by the appended claims and their legal equivalents.

What is claimed is:

1. A backlight module structure comprising a front frame and a back cover cooperating with each other, and a middle frame and a light guide plate disposed between the front frame and the back cover, wherein the middle frame is made of an rubber material, and a lateral side of the light guide plate is engaged with an inner side of the middle frame, when the light guide plate produces expansion due to absorbing thermal energy and moisture, the expansion is absorbed by the middle frame, and the light guide plate is recovered from being expanded by elasticity when the external environment is restored to normal.

2. The backlight module structure of claim 1, wherein the backlight module structure further comprises a reflective film being disposed under a bottom of the light guide plate.

3. The backlight module structure of claim 2, wherein a bottom of the reflective film which is disposed on the back cover.

4. The backlight module structure of claim 1, wherein the backlight module structure further comprises an optical film being disposed on a light emitting surface of the light guide plate.

5. The backlight module structure of claim 1, wherein the backlight module structure further comprises light-bar being installed at a light entrance surface of the light guide plate.

6. The backlight module structure of claim 1, wherein the backlight module structure further comprises a heat conduction glue strip being adhered between the light-bar and an inner of the back cover.

7. A backlight module structure comprising a front frame and a back cover cooperating with each other, and a middle frame and a light guide plate being disposed between the front frame and the back cover, wherein the middle frame is made of an elastic material, a lateral side of the light guide plate is engaged with an inner side of the middle frame.

8. The backlight module structure of claim 7, wherein the lateral side of the light guide plate is engaged with an inner side of the middle frame, when the light guide plate produces expansion due to absorbing thermal energy and moisture, the expansion is absorbed by the middle frame, and the light guide plate is recovered from being expanded by elasticity when an external environment is restored to normal.

9. The backlight module structure of claim 7, wherein the middle frame is made of a rubber material.

10. A liquid crystal display device comprising a front frame and a back cover cooperating with each other, and a middle frame and a light guide plate being disposed between the front frame and the back cover, wherein the middle frame is made of an elastic material, and a lateral side of the light guide plate is engaged with an inner side of the middle frame.

11. The liquid crystal display device of claim 10, wherein when the light guide plate absorbs thermal energy and moisture, the light guide plate produces expansion which is absorbed by the middle frame, and the light guide plate is recovered from being expanded by elasticity when the external environment is restored to normal.

12. The liquid crystal display device of claim 10, wherein the middle frame is made of a rubber material.

13. The liquid crystal display device of claim 10, wherein the backlight module structure further comprises a reflective film being disposed under a bottom of the light guide plate.

14. The liquid crystal display device of claim 13, wherein a bottom of the reflective film being disposed on the back cover.

15. The liquid crystal display device of claim 10, wherein the backlight module structure further comprises an optical film being disposed on a light emitting surface of the light guide plate.
